(19) United States
(12) Patent Application Publication
(10) Pub. No.: US 2010/0287569 A1
(43) Pub. Date: Nov. 11, 2010

(54) COMPUTER, INPUT METHOD, AND COMPUTER-READABLE MEDIUM

(75) Inventor: Kuan-Wen CHEN, TAIPEI CITY (TW)

Correspondence Address: BRIAN M. MCINNIS, 12th Floor, Ruttonjee House, 11 Duddell Street, Hong Kong, HK

(73) Assignee: Kuan-Wen CHEN, TAIPEI CITY (TW)

(21) Appl. No.: 12/612,658

(22) Filed: Nov. 4, 2009

(30) Foreign Application Priority Data
Nov. 6, 2008 (TW) 97142945
Nov. 6, 2008 (TW) 97219895

(51) Int. Cl. G06F 9/46

(52) U.S. Cl. 719/324

(57) ABSTRACT

A computer is disclosed. The computer includes a hardware human interface device and a processor. The processor programs the following steps. A plurality of application programs are executed by the processor. A plurality of virtual logical human interface devices are provided to the processor. The virtual logical human interface devices are assigned to the application programs respectively for allowing the application programs to interact with the hardware human interface device in different ways.

### RELATED APPLICATIONS

The application claims priority to Taiwan Application Serial Number 97142945, filed Nov. 6, 2008, and also claims priority to Taiwan Application Serial Number 97219895, filed Nov. 6, 2008, which are herein incorporated by reference.

### BACKGROUND

1. Technical Field

The present disclosure relates to computers and digital processing systems.

2. Description of Related Art

A hardware human interface device is necessary for a computer, such as mouse, keyboard, or joypad. When the hardware human interface device is connected to the computer, an operating system which is installed in the computer would provide a device driver for the hardware human interface device, or the user has to install a device driver in the operating system to drive the hardware human interface device.

### SUMMARY

According to one embodiment of the present disclosure, a computer includes at least one hardware human interface device and a processor. The processor is programmed to perform the following steps. A plurality of application programs are executed by the processor. A plurality of virtual logical human interface devices are provided to the computer. The virtual logical human interface devices are assigned to the application programs respectively for allowing the application programs to interact with the hardware human interface device in different ways.

According to another embodiment of the present disclosure, an input method includes following steps. At least one application program is executed by a computer. A plurality of virtual logical human interface devices are provided to the computer. One of the virtual logical human interface devices is selected to allow the application program to interact with the hardware human interface device of the computer.

According to another embodiment of the present disclosure, a computer-readable medium includes computer-executable instructions for performing following steps. At least one application program is executed by a computer. A plurality of virtual logical human interface devices are provided to the computer. One of the virtual logical human interface devices is selected to allow the application program to interact with the hardware human interface device of the computer.

The foregoing steps are not recited in the sequence in which the steps are performed. That is, unless the sequence of the steps is expressly indicated, the sequence of the steps is interchangeable, and all or part of the steps may be simultaneously, partially simultaneously, or sequentially performed.

### BRIEF DESCRIPTION OF THE DRAWINGS

FIG. 1 is a function block diagram of a computer according to one embodiment of the present disclosure.

FIG. 2 is a three-dimensional view of the computer of FIG. 1.

FIG. 3 is a front view of a computer according to another embodiment of the present disclosure.

FIG. 4 is a three-dimensional view of a computer according to yet another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

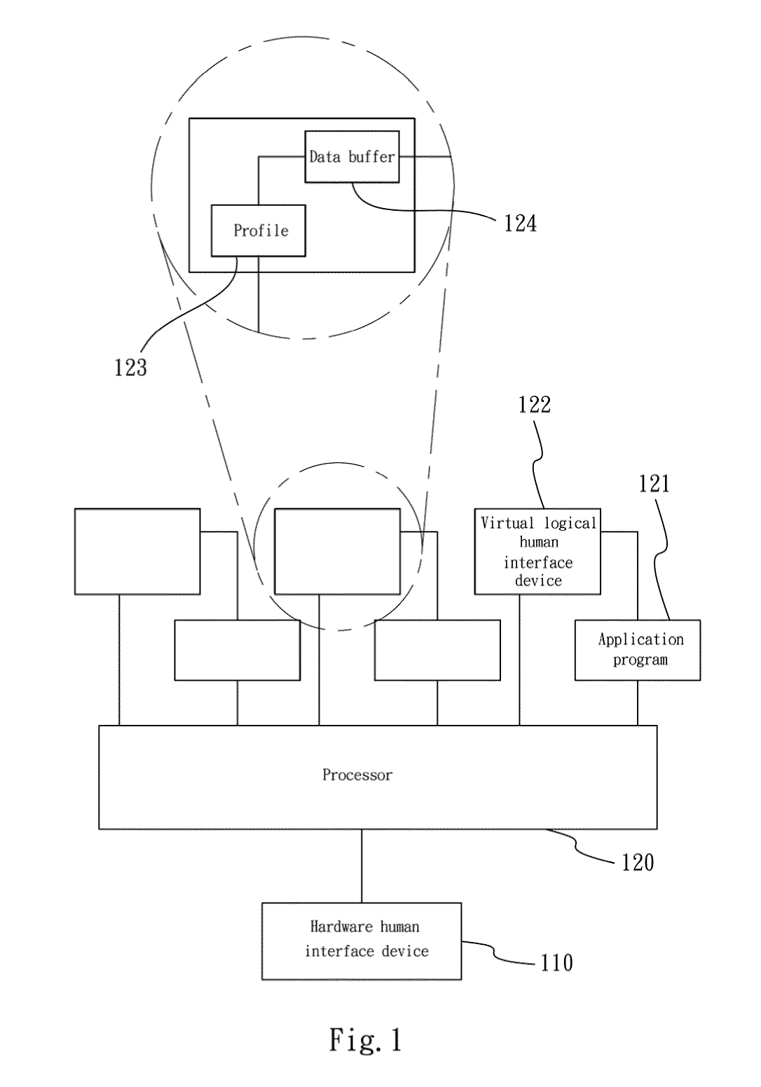

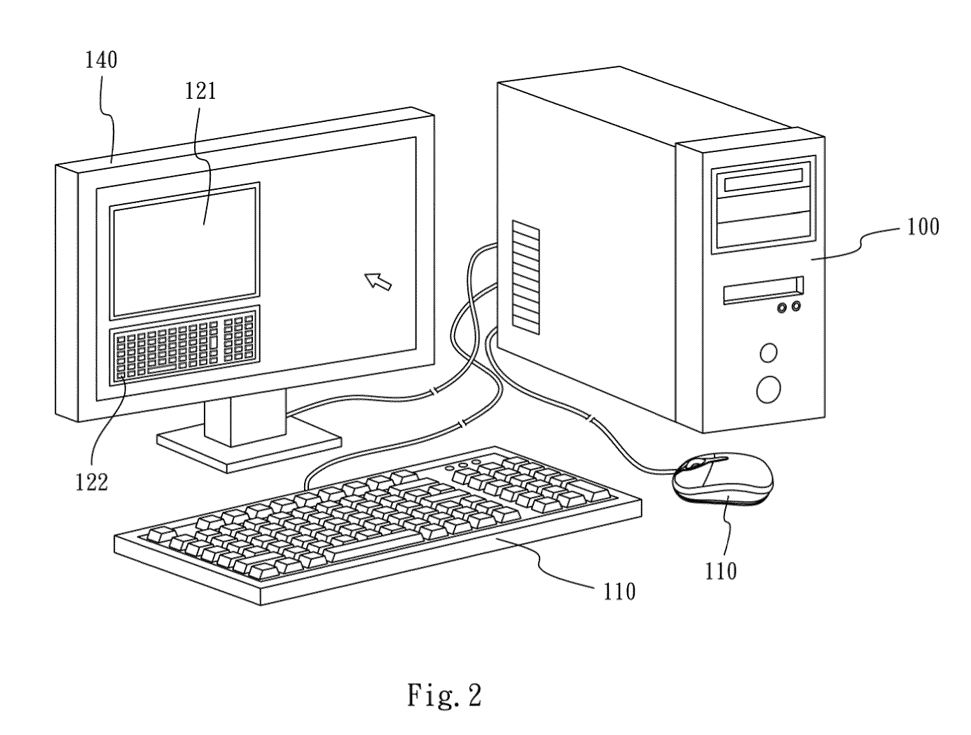

FIG. 1 is a function block diagram of a computer 100 according to one embodiment of the present disclosure. FIG. 2 is a three-dimensional view of the computer 100 of FIG. 1. The computer 100 includes a hardware human interface device 110 and a processor 120. The processor 120 is programmed to perform the following steps. A plurality of application programs 121 are executed by the processor 120. A plurality of virtual logical human interface devices 122 are provided to the computer 120. The virtual logical human interface devices 122 are assigned to the application programs 121 respectively for allowing the application programs 121 to interact with the hardware human interface device 110 in different ways.

At least one of the virtual logical human interface devices 122 includes a profile 123, and the profile 123 contains a series of commands. The profile 123 is activated by one or more hot keys of the hardware human interface device 110. When the hot key is triggered, the application program 121 associated with the virtual logical human interface device 122 will executes the commands.

For instance, the commands contained in the profile 123 are set to input the numbers “1”, “2”, “3”, and “4”, move the cursor left fifty grids, and perform a left single-click (i.e. clicking the left button of the mouse). Moreover, the profile 123 is activated by the hot key “A” of the keyboard. In use, when the user triggers the hot key “A”, the numbers “1”, “2”, “3”, and “4” will be inputted into the computer 100 first, then the cursor will be moved left fifty grids, and then a is left single-click will be performed.

In other words, the virtual logical human interface devices 122 can include a plurality of profiles 123. Thus, the virtual logical human interface devices 122 can provide a specific series of commands for each application program 121.

Each of the virtual logical human interface devices 122 includes at least one data buffer 124. In use, the data buffer 124 can temporarily hold holding data intended to be sent to one of the application programs, e.g. the commands intended to be executed by one of the application programs.

For instance, if the virtual logical human interface device 122 is intended to be a logical keyboard, the data buffer 124 may have eight bits to temporarily hold the commands, such as the scancodes of the keys “Alt”, “Ctrl”, “Shift”, and other five keys of the keyboard. For another instance, if the virtual logical human interface device 122 is intended to be a logical mouse, the data buffer 124 may have four bits to temporarily hold the commands, such as the button ID, the coordinate of the X axis, the coordinate of the Y axis, and the mouse ball data of the mouse. As stated before, when the user triggers the hot key “A”, the commands are held in the data buffer 124, and the application program 121 executes the commands from the data buffer 124. Therefore, the computer 100 is inputted “1234”, and the cursor of the mouse is moved left fifty grids, and the left button of the mouse is clicked. In one embodiment, the application program 121 executes the commands repetitively, only if the hot key “A” is inputted again.

In other words, the virtual logical human interface devices 122 can include a plurality of data buffers 124. More commands can be held in the buffers 124 for being sent to the application program 121.

A part of the code of the virtual logical human interface devices 122 is shown below:

Application communication with virtual hid mindriver
//Starts the input program by CreateFile

file = CreateFile ( deviceInterfaceDetailData−>DevicePath,

```
  GENERIC_READ | GENERIC_WRITE,
  FILE_SHARE_READ | FILE_SHARE_WRITE, //
```

FILE_SHARE_READ | FILE_SHARE_READ |

NULL, // no SECURITY_ATTRIBUTES structure
OPEN_EXISTING, // No special create flags
0, // No special attributes
NULL); // No template file
if (INVALID_HANDLE_VALUE == file) {

printf(“Error: CreateFile failed: % d\n”, GetLastError());
TRACE(“%s,CreateFile

fail\n”,deviceInterfaceDetailData−>DevicePath);

free (deviceInterfaceDetailData);
return FALSE;

}
PHIDP_PREPARSED_DATA Ppd; // The opaque parser info describing

this device

| | |
|---|---|
| HIDP_CAPS | Caps; // The Capabilities of this hid device. |

| | |
|---|---|
| USAGE | MyUsagePage =0x01 ;//0xff00; |

| | |
|---|---|
| USAGE | MyUsage = 0x04;//0x0001; |

```
  DWORD bytesWritten=0;
  if (!HidD_GetPreparsedData (file, &Ppd))
  {
```

printf(“Error: HidD_GetPreparsedData failed \n”);
return FALSE;

```
  }
  if (!HidP_GetCaps (Ppd, &Caps))
  {
```

printf(“Error: HidP_GetCaps failed \n”);
HidD_FreePreparsedData (Ppd);
return FALSE;

}
printf(“Caps.UsagePage:%x,Caps.Usage=%x ,Caps.InputReportByteLen

gth =%d\n”,Caps.UsagePage,Caps.Usage,Caps.InputReportByteLength );

if ((Caps.UsagePage == MyUsagePage) && (Caps.Usage ==

MyUsage))

{

TRACE(“Success: Found my device.. \n”);

GetBuffer(OutputBuffer);

//access the buffer and write data to the buffer by WriteFile

WriteFile (file,

OutputBuffer,
Caps.OutputReportByteLength,
&bytesWritten,
NULL);//SendHidRequests(file);

TRACE(“Caps.OutputReportByteLength:%d,bytesWritten:%d\n”,Caps.O

utputReportByteLength,bytesWritten);

```
  }
CloseHandle(file);
  free (deviceInterfaceDetailData);
```

The amount of the hardware human interface devices 110 are 256 in one to computer 100 of current technique, and the mouse and the keyboard are one kind of hardware human interface devices 110. Therefore, the amount of the virtual logical human interface devices 122 are 254. More than one virtual logical human interface devices 122 can be assigned to one application program 121. More than one profile 123 can be assigned to one hot key. The profile 123 can be edited by the user to change the commands and the hot key. The virtual logical human interface device 122 can be edited by the user to change the application program 121 what the virtual logical human interface device 122 is assigned to.

The hardware human interface device 110 can electrically connect to the processor 120. Moreover, the hardware human interface device 110 can be connected to the computer 100 through the Internet. Furthermore, the hardware human interface device 110 may be a keyboard, a mouse, or a joypad.

When many users connect to the computer 100, each user controls at least one virtual logical human interface device 122. If all of the virtual logical human interface devices 122 are assigned to the same application program 110, each user can trigger the hot key by their own hardware human interface device 110, and the application program 121 executes all profiles 123 of the virtual logical human interface devices 122. If all of the virtual logical human interface devices 122 are not assigned to the same application program 110, each user can trigger the hot key and each application program 121 executes the profile 123 of the virtual logical human interface devices 122. Therefore, one application program 110 can be operated by many users in the computer 100, and users can operate different application programs 121 in the computer 100.

Regarding FIG. 2, one of the application programs 110 may be an operating system. The operating system assigns identification numbers to the virtual logical human interface devices 122 respectively. Therefore, the virtual logical human interface devices 110 are registered to the operating system.

The operating system is showed on the monitor 140 of the computer 100. An application program 121 is operated and shown on the monitor 140. A virtual logical human interface device 122 which is assigned to the application program 122 is executed and shown on the monitor 140, and the profile 123 of the virtual logical human interface device 122 is assigned to the hot key of the hardware human interface device 110. When the user operates the operating system, the user can trigger the hot key to send the commands to the application program 121, and the application program 121 executes the commands. Therefore, the user can operate the operating system and the application program 121 at the same time.

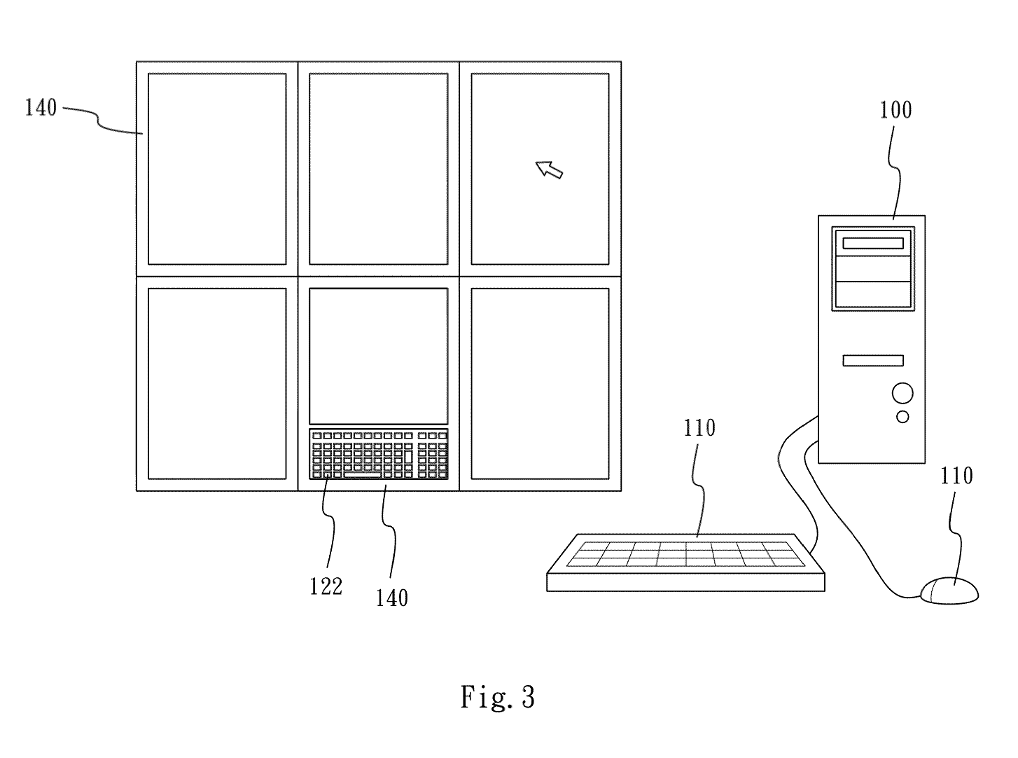

FIG. 3 is a front view of FIG. 2, depicting the computer 100 includes many monitors 140. The computer 100 has a plurality of operating systems and monitors 140, and each of the monitors 140 is shown an operating system. A virtual logical human interface device 122 is shown on one monitor 140, and the virtual logical human interface device 122 is assigned to the operating system which is shown on the monitor 140 what the virtual logical human interface device 122 is shown. When the user operates another operating system, the user can trigger the hot key to send the commands to the application program 121, and the operating system executes the commands. Therefore, the user can operate two operating systems which are shown on two monitors 140 respectively at the same time.

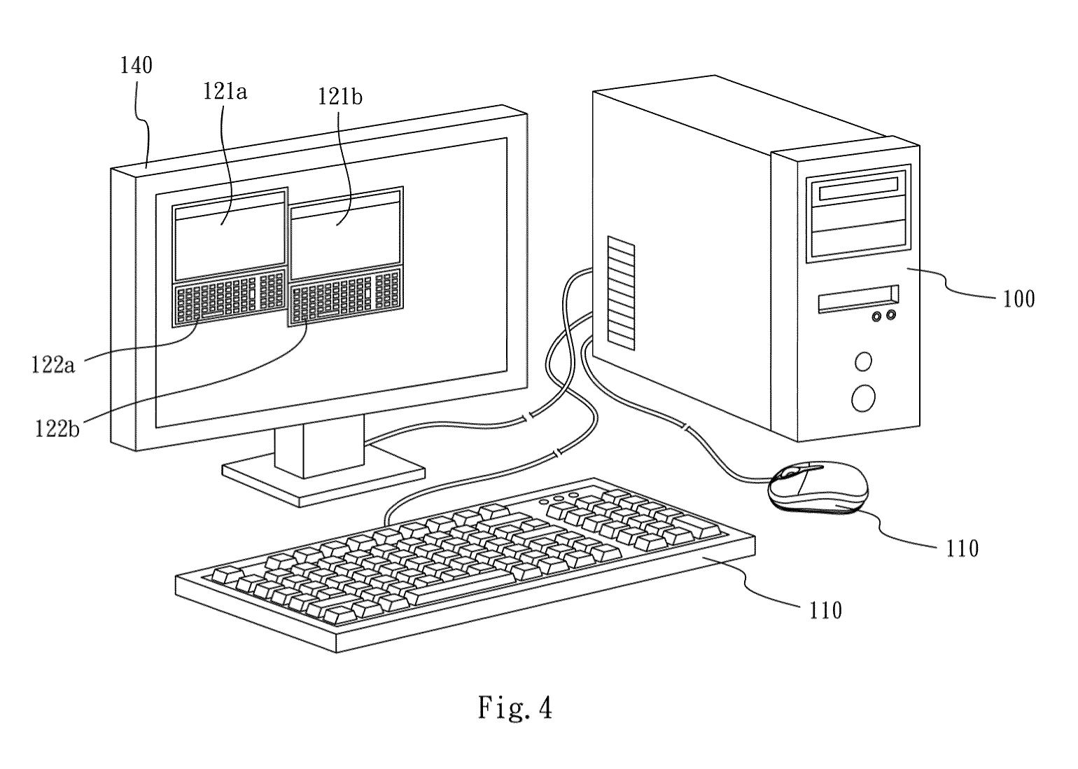

FIG. 4 is a three-dimensional view of FIG. 2, depicting the computer 100 operates two application programs 121.

A first application program 121A and a second application program 121B are shown on the monitor 140. A first virtual logical human interface device 122A and a second virtual logical human interface device 122B are shown on the monitor 140. The first virtual logical human interface device 122A is assigned to the first application program 121A, and the second virtual logical human interface device 122B is assigned to the second application program 121B. The profiles 123 of the first virtual logical human interface device 122A and the second virtual logical human interface device 122B are assigned to different hot keys of the hardware human interface device 110. Therefore, the user can operate two application programs 121 by different hot keys. Furthermore, the profiles 123 of the first virtual logical human interface device 122A and the second virtual logical human interface device 122B can be assigned to the same hot key. Therefore, the user can operate two application programs 121 at the same time.

Moreover, the first virtual logical human interface device 122A and the second virtual logical human interface device 122B can be assigned to different hot keys which are disposed on different hardware human interface devices 110, such as mouse and keyboard. If the commands of the two virtual logical human interface devices 122A, 122B are the same, the mouse and the keyboard can execute the same function. Therefore, the user can use the keyboard to replace the function of the mouse, and the user can use the mouse and the keyboard as two mice.

According to another embodiment of the present disclosure, an input method includes following steps. At least one application program is executed by a computer. A plurality of virtual logical human interface devices are provided to the computer. One of the virtual logical human interface devices is selected to allow the application program to interact with the hardware human interface device of the computer.

And the method further includes the following steps. A series of commands are saved into a profile. The commands are sent to the application program by the selected virtual logical human interface device when the hot key of the hardware human interface device of the computer is triggered. The commands are executed by the application program.

Furthermore, the virtual logical human interface devices are provided to the computer by the following steps. The virtual logical human interface devices are simulated in the computer. Identification numbers are assigned to the virtual logical human interface devices respectively. The virtual logical human interface devices are registered to the operating system of the computer.

Moreover, when the virtual logical human interface devices are provided to the computer, at least one data buffer is established in each of the virtual logical human interface devices for temporarily holding data intended to be sent to the application program.

According to another embodiment of the present disclosure, a computer-readable medium is provided. The computer-readable medium includes computer-executable instructions for performing the steps mentioned before.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A computer comprising:
at least one hardware human interface device; and
a processor programmed to:
execute a plurality of application programs;
provide a plurality of virtual logical human interface devices;
assign the virtual logical human interface devices to the application programs respectively for allowing the application programs to interact with the hardware human interface device in different ways.

2. The computer of claim 1, wherein at least one of the virtual logical human interface devices comprises:
at least one profile containing a series of commands intended to be executed by one of the application programs when the hot key of the hardware human interface device is triggered.

3. The computer of claim 1, wherein the virtual logical human interface devices each comprises:
at least one data buffer for temporarily holding data intended to be sent to one of the application programs.

4. The computer of claim 1, wherein the hardware human interface device is electrically connected to the processor.

5. The computer of claim 1, wherein the hardware human interface device is connected to the computer through the internet.

6. An input method comprising:
executing at least one application program by a computer;
providing a plurality of virtual logical human interface devices to the computer; and
selecting one of the virtual logical human interface devices to allow the application program to interact with the hardware human interface device of the computer.

7. The input method of claim 6, further comprising:
saving a series of commands into a profile;
sending the series of commands to the application program by the is selected virtual logical human interface device when the hot key of the hardware human interface device of the computer is triggered; and
executing the series of commands by the application program.

8. The input method of claim 6, wherein providing the virtual logical human interface devices to the computer comprises:
simulating the virtual logical human interface devices in the computer; and
assigning identification numbers to the virtual logical human interface devices respectively; and
registering the virtual logical human interface devices to the operating system of the computer.

9. The input method of claim 8, wherein providing the virtual logical human interface devices to the computer comprises:
establishing at least one data buffer in each of the virtual logical human interface devices for temporarily holding data intended to be sent to the application program.

10. A computer-readable medium comprising computer-executable instructions for performing steps of:
executing at least one application program by a computer;
providing a plurality of virtual logical human interface devices to the computer; and
selecting one of the virtual logical human interface devices to allow the application program to interact with the hardware human interface device of the computer.

11. The computer-readable medium of claim 10 comprising further computer-executable instructions for performing steps of:
saving a series of commands into a profile;
sending the series of commands to the application program by the selected virtual logical human interface device when the hot key of the hardware human interface device of the computer is triggered; and
executing the series of commands by the application program.

12. The computer-readable medium of claim 10, wherein providing the virtual logical human interface devices to the computer comprises:
simulating the virtual logical human interface devices in the computer; and
assigning identification numbers to the virtual logical human interface devices respectively; and
registering the virtual logical human interface devices to the operating system of the computer.

13. The computer-readable medium of claim 12, wherein providing the virtual logical human interface devices to the computer comprises:
establishing at least one data buffer in each of the virtual logical human interface devices for temporarily holding data intended to be sent to the application program.
